(19) United States
(12) Patent Application Publication
(10) Pub. No.: US 2025/0211797 A1
(43) Pub. Date: Jun. 26, 2025

(54) IN-LOOP FILTERS AT VIRTUAL BOUNDARIES

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US)

(21) Appl. No.: 18/850,327

(22) PCT Filed: Mar. 8, 2023
(86) PCT No.: PCT/EP2023/055850

§ 371 Date: Sep. 24, 2024

Related U.S. Application Data
(60) Provisional application No. 63/362,243, filed on Mar. 31, 2022.

(51) Int. Cl. H04N 19/82; H04N 19/117; H04N 19/167; H04N 19/172; H04N 19/86

(52) U.S. Cl. CPC H04N 19/82; H04N 19/117; H04N 19/167; H04N 19/172; H04N 19/86

(57) ABSTRACT

An apparatus may be configured to: select at least one first pixel from a first region of a picture, wherein the first region is separated from a different, second region with a virtual boundary; determine at least one second pixel for filtering of the at least one first pixel, wherein the at least one second pixel is located in the second region; determine whether to filter the at least one first pixel; and based on a determination to filter the at least one first pixel, cause filtering of the at least one first pixel based on at least one of: coding information associated with the at least one second pixel; at least one predetermined value; or a version of the coding information associated with the at least one second pixel padded based on coding information of the first region.

### TECHNICAL FIELD

The example and non-limiting embodiments relate generally to input to filters and, more particularly, to in-loop filters with respect to virtual boundaries.

### BACKGROUND

It is known, in versatile video coding, to not perform in-loop filtering across virtual boundaries.

### SUMMARY

The following summary is merely intended to be illustrative. The summary is not intended to limit the scope of the claims.

In accordance with one aspect, an apparatus comprising: at least one processor; and at least one memory including computer program code; the at least one memory and the computer program code configured to, with the at least one processor, cause the apparatus at least to: select at least one first pixel from a first region of a picture, wherein the first region is separated from a different, second region with a virtual boundary; determine at least one second pixel for filtering of the at least one first pixel, wherein the at least one second pixel is located in the second region; determine whether to filter the at least one first pixel; and based on a determination to filter the at least one first pixel, cause filtering of the at least one first pixel based on at least one of: coding information associated with the at least one second pixel; at least one predetermined value; or a version of the coding information associated with the at least one second pixel padded based on coding information of the first region.

In accordance with one aspect, a method comprising: selecting at least one first pixel from a first region of a picture, wherein the first region is separated from a different, second region with a virtual boundary; determining at least one second pixel for filtering of the at least one first pixel, wherein the at least one second pixel is located in the second region; determining whether to filter the at least one first pixel; and based on a determination to filter the at least one first pixel, filtering the at least one first pixel based on at least one of: coding information associated with the at least one second pixel; at least one predetermined value; or a version of the coding information associated with the at least one second pixel padded based on coding information of the first region.

In accordance with one aspect, an apparatus comprising means for performing: selecting at least one first pixel from a first region of a picture, wherein the first region is separated from a different, second region with a virtual boundary; determining at least one second pixel for filtering of the at least one first pixel, wherein the at least one second pixel is located in the second region; determining whether to filter the at least one first pixel; and based on a determination to filter the at least one first pixel, filtering the at least one first pixel based on at least one of: coding information associated with the at least one second pixel; at least one predetermined value; or a version of the coding information associated with the at least one second pixel padded based on coding information of the first region.

In accordance with one aspect, a non-transitory computer-readable medium comprising program instructions stored thereon which, when executed with at least one processor, cause the at least one processor to: select at least one first pixel from a first region of a picture, wherein the first region is separated from a different, second region with a virtual boundary; determine at least one second pixel for filtering of the at least one first pixel, wherein the at least one second pixel is located in the second region; determine whether to filter the at least one first pixel; and based on a determination to filter the at least one first pixel, cause filtering of the at least one first pixel based on at least one of: coding information associated with the at least one second pixel; at least one predetermined value; or a version of the coding information associated with the at least one second pixel padded based on coding information of the first region.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a block diagram of one possible and non-limiting exemplary system in which the exemplary embodiments may be practiced;

FIG. 3 is a diagram illustrating features as described herein;

herein; FIG. 4 is a diagram illustrating features as described

FIG. 5 is a diagram illustrating features as described herein;

FIG. 6 is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10 is a diagram illustrating features as described herein;

FIG. 11 is a diagram illustrating features as described herein;

FIG. 12 is a diagram illustrating features as described herein;

FIG. 13 is a diagram illustrating features as described herein;

FIG. 14 is a diagram illustrating features as described herein;

FIG. 15 is a diagram illustrating features as described herein;

FIG. 16 is a diagram illustrating features as described herein;

FIG. 17 is a diagram illustrating features as described herein;

FIG. 18 is a diagram illustrating features as described herein;

FIG. 19 is a diagram illustrating features as described herein; and

FIG. 20 is a flowchart illustrating steps as described herein.

### DETAILED DESCRIPTION OF EMBODIMENTS

The following abbreviations that may be found in the specification and/or the drawing figures are defined as follows:
4G fourth generation
5G fifth generation
5GC 5G core network
ANN artificial neural network
ALF adaptive loop filter
BIF bilateral filter
CCALF cross-component ALF
CCSAO cross-component SAO
CDMA code division multiple access
CPU central processing unit
CTU coding tree unit
CU coding unit
DSP digital signal processor
ECM enhanced compression model
eNB (or eNodeB) evolved Node B (e.g., an LTE base station)
E-UTRA evolved universal terrestrial radio access, i.e., the LTE radio access technology
GDR gradual decoding refresh
gNB (or gNodeB) base station for 5G/NR, i.e., a node providing NR user plane and control plane protocol terminations towards the UE, and connected via the NG interface to the 5GC
FDMA frequency division multiple access
GPU graphical processing unit
GSM global systems for mobile communications
HMD head-mounted display
IEEE Institute of Electrical and Electronics Engineers
IMD integrated messaging device
IMS instant messaging service
IoT Internet of Things
joint video experts team JVET
LTE long term evolution
MMS multimedia messaging service
MPEG-I Moving Picture Experts Group immersive codec family
MV motion vector
ng or NG new generation
ng-eNB or NG-eNB new generation eNB
NR new radio
PC personal computer
PDA personal digital assistant
QP quarter pixel
SAO sample adaptive offset
SMS short messaging service
SPS sequence parameter set
TCP-IP transmission control protocol-internet protocol
TDMA time division multiple access
UICC universal integrated circuit card
UMTS universal mobile telecommunications system
VVC versatile video coding

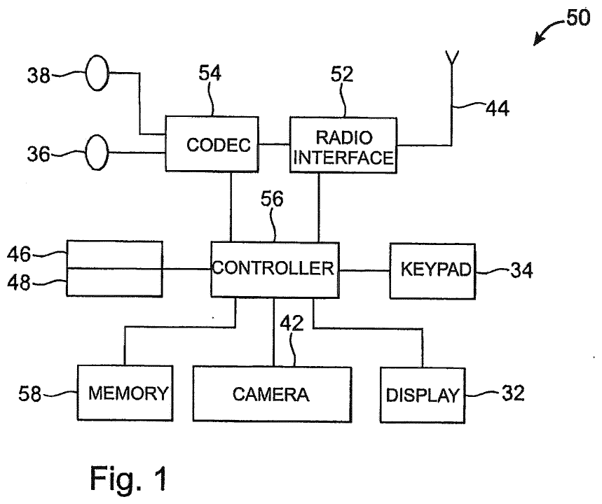

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-I) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that embodiments of the invention may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in embodiments of the invention may be any one of: an earpiece, speaker, or an analogue audio or digital audio output connection. The electronic device 50 may also comprise a battery (or in other embodiments of the invention the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other embodiments the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device 50 may further comprise an input device 34, such as a keypad, one or more input buttons, or a touch screen input device, for providing information to the controller 56.

The electronic device 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise a camera 42 or other sensor capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

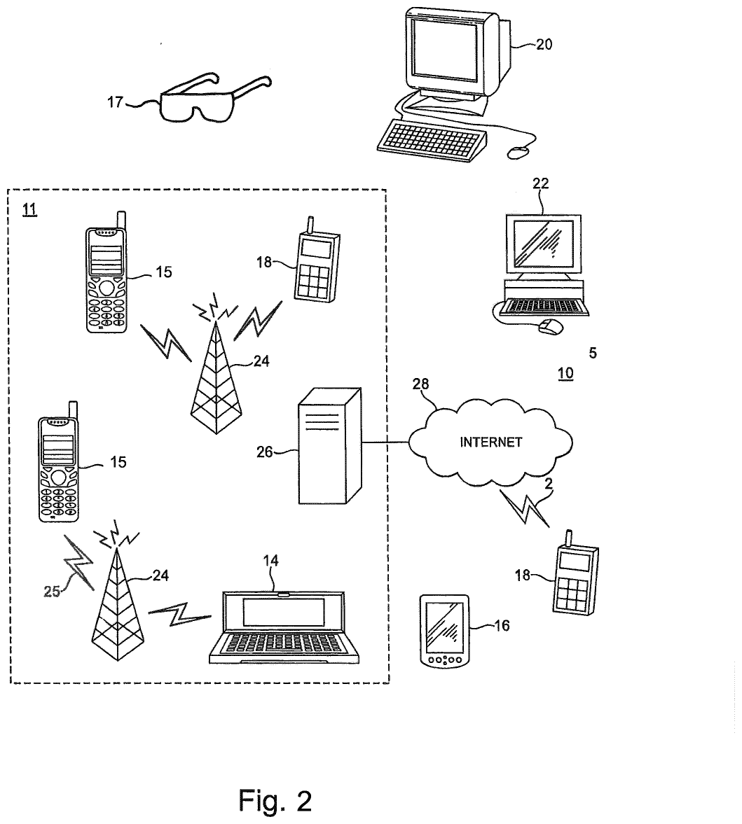

With respect to FIG. 2, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G network etc.), a wireless local area network (WLAN) such as defined by any of the IEEE 802.x standards, a BLUETOOTH™ personal area network, an Ethernet local area network, a token ring local area network, a wide area network, and/or the Internet.

The system 10 may include both wired and wireless communication devices and/or electronic devices suitable for implementing embodiments of the invention.

For example, the system shown in FIG. 2 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The embodiments may also be implemented in cellular telephones such as smart phones, tablets, personal digital communication capabilities, assistants (PDAs) having wireless portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTH™, IEEE 802. 11, 3GPP Narrowband IoT and any similar wireless communication technology. A communications device involved in implementing various embodiments of the present invention may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Features as described herein generally relate to virtual boundaries. The concept of virtual boundaries was introduced in Versatile Video Coding (VVC) (B. Bross, J. Chen, S. Liu, Y-K Wang, “Versatile Video Coding”, JVET-02001-vE, June 2020). In an example, a picture may be divided into different regions by/using virtual boundaries from a coding dependency perspective. For example, virtual boundaries may be used to define the boundaries of different faces of a 360° picture in a CMP file format. In another example, a virtual boundary may be used to separate refreshed area(s) and non-refreshed area(s) of a gradual decoding refresh (GDR)/recovering picture (see L. Wang, S. Hong and K. Panusopone, “Gradual Decoding Refresh for VVC”, JVET-Q0527, January 2020; S. Hong, L. Wang and K. Panusopone, “GDR Software”, JVET-T0078, October 2020). In another example, in versatile video coding (VVC), virtual boundaries may be specified in sequence parameter set (SPS) and/or picture header.

Features as described herein may relate to in-loop filters in VVC and enhanced compression model (ECM), although this is not limiting. There are three in-loop filters in VVC: deblocking, sample adaptive offset (SAO), and adaptive loop filter (ALF). ECM may enhance the in-loop filters with new features, including Bilateral (JVET-F0034, JVET-V0094, JVET-X0067), Cross-Component SAO (CCSAO) (JVET-V0153), Longer Cross-Component ALF (CCALF) (JVET-X0045), Alternative Band Classifier for ALF (JVET-X0070), and CCSAO EDGE classifier (JVET-Y0106) (see e.g. M. Coban, F. Leannec, M. G. Sarwer and J. Strom, “Algorithm description of Enhanced Compression Model 3 (ECM 3)”, JVET-X2025, January 2022).

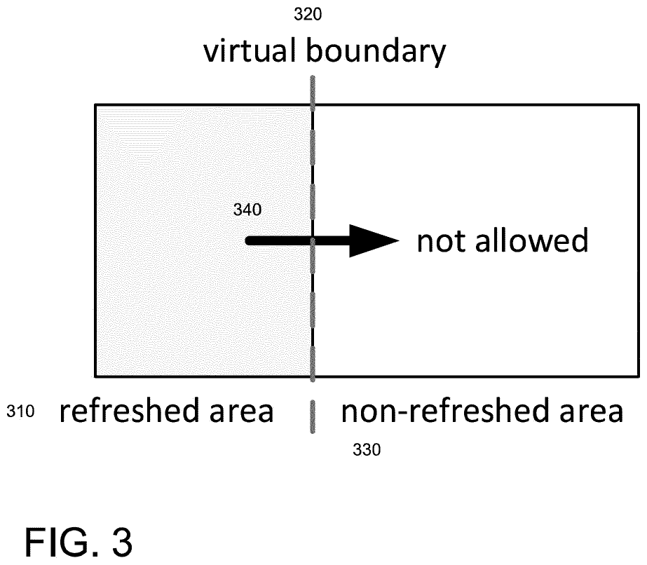

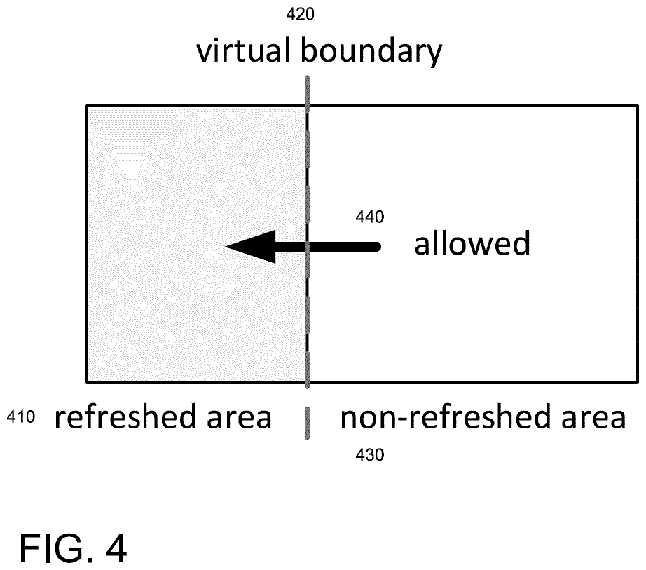

In-loop filtering of a current pixel often requires use of coding information of its neighbors. Hence, filtering on one side of a virtual boundary may involve the use of coding information on the other side of the virtual boundary. However, for some applications, it may not be desirable to have filtering cross a virtual boundary. For example, in GDR, a GDR/recovering picture may be divided into a refreshed area(s) and non-refreshed area(s) by a virtual boundary(s). To avoid leaks, the refreshed area cannot use any information of the non-refreshed area, as shown in FIG. 3, because there is no guarantee that the non-refreshed area will be decoded correctly at decoder. Incorrectly decoded coding information may contaminate the refreshed area, which may result in leaks. Hence, for a GDR/recovering picture, in-loop filtering cannot cross the virtual boundary from refreshed area to non-refreshed area.

Referring now to FIG. 3, illustrated is refreshed area 310 separated by virtual boundary 320 from non-refreshed area 330. In-loop filtering of a pixel of the refreshed area 310 based on coding information of the non-refreshed area 330 may not be allowed, as indicated by the arrow 340.

In other scenarios, it may be perfectly fine to let filtering cross a virtual boundary. For example, in the same example of GDR, the non-refreshed area may use information of the refreshed area, as shown in FIG. 4. Hence, for a GDR/recovering picture, in-loop filtering may cross the virtual boundary from non-refreshed area to refreshed area.

Referring now to FIG. 4, illustrated is refreshed area 410 separated by virtual boundary 420 from non-refreshed area 430. In-loop filtering of a pixel of the non-refreshed area 430 based on coding information of the refreshed area 410 may be allowed, as indicated by the arrow 440.

In the current version of VVC, in-loop filtering may not be allowed to cross virtual boundaries. In example embodiments of the present disclosure, (in-loop) filtering on one side of a virtual boundary may be allowed to use coding information (pixels, coding modes, motion vectors (MVs), quarter pixels (QPs), etc.) on other side of the virtual boundary. Additionally or alternatively, in example embodiments of the present disclosure, (in-loop) filtering on one side of a virtual boundary may not be allowed to use coding information (pixels, coding modes, MVs, QPs, etc.) on other side of the said virtual boundary. The choice for using or not using the coding information on the other side of the virtual boundary may be default, or may be signaled in Sequence Header and/or Picture Header and/or Slice Header. In other words, there may be a determination as to whether to perform filtering for a pixel on one side based on a pixel on the other side of a virtual boundary. If it is determined to perform the filtering, the filtering may be performed according to an example embodiment of the present disclosure. If it is determined to not perform the filtering, filtering of the pixel on the one side may be omitted, or not performed. In an example embodiment, filtering of a pixel on one side based on a pixel on the other side of a virtual boundary may only be performed if, based on a default value/setting/configuration or received signaling, it is determined that such filtering should be performed.

In an example embodiment of the present disclosure, a filtering operation on one side of a virtual boundary may not use coding information on other side of the virtual boundary, and filtering operation on the other side of the virtual boundary may not use coding information on the one side of the said virtual boundary either. In this scenario, filtering may not cross the virtual boundary from either the one side or the other side. In other words, there is not an option for use of coding information of an opposite side of a virtual boundary for a filtering operation.

In an example embodiment of the present disclosure, a filtering operation on one side of a virtual boundary may not use coding information on the other side of the said virtual boundary, but a filtering operation on the other side of the virtual boundary is allowed to use coding information on the one side of the virtual boundary. In this scenario, filtering may not cross the said virtual boundary from the said one side, but can cross from the said other side. In other words, unidirectional use of coding information in a first direction only may be possible.

In an example embodiment of the present disclosure, a filtering operation on one side of a virtual boundary may be allowed to use coding information on the other side of the said virtual boundary, but filtering operation on the said other side of the said virtual boundary may not use coding information on the one side of the said virtual boundary. In this scenario, filtering can cross the said virtual boundary from the one side, but not from the other side. In other words, unidirectional use of coding information in a second direction only may be possible.

In an example embodiment of the present disclosure, a filtering operation on one side of a virtual boundary may be allowed to use coding information on the other side of the virtual boundary, and filtering operation on the other side of the said virtual boundary may also be allowed to use coding information on the one side of the virtual boundary. In this scenario, filtering may cross the virtual boundary from the one side and also from the other side. In other words, bidirectional use of coding information in both a first direction and a second direction may be possible.

In an example embodiment, (in-loop) filtering for a pixel on one side of a virtual boundary may require coding information on the other side of the virtual boundary. If the coding information on the other side of the said virtual boundary is not allowed to be used for the pixel on the one side of the virtual boundary, an implementation/option may be to disable the filtering for the pixel on the one side of the said virtual boundary. Alternatively, an option is to still perform the filtering for the pixel on the one side of the virtual boundary, but with the coding information on the other side of the virtual boundary being replaced with coding information (padded or derived) from the one side of the virtual boundary, or with coding information set to pre-determined values. In other words, the filtering may still be performed without using the coding information of the other side of the virtual boundary, but rather using some other, replacement coding information instead. The replacement coding information may be at least partially different from the coding information of the other side of the virtual boundary.

In an example embodiment, a deblocking filtering may be applied to a (horizontal or vertical) boundary of a block, involving four (horizontal or vertical) pixels on each side of the block boundary and other coding information sourced from both sides of the virtual boundary. In an example embodiment, it may be assumed that the block boundary is aligned with the virtual boundary.

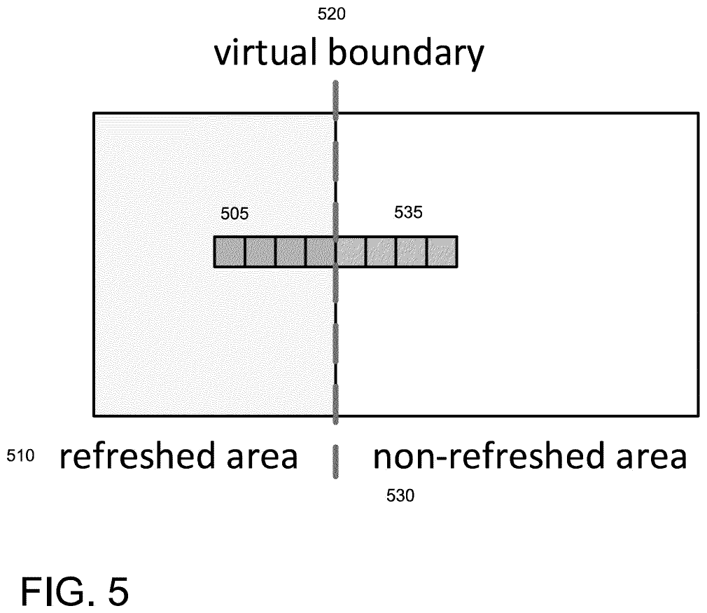

If one side of a virtual boundary is not allowed to use coding information on the other side of the virtual boundary, a deblocking filtering may not be applied within four pixels on the one side, next to the virtual boundary. As shown in the example of FIG. 5, the refreshed area of a GDR/recovering picture may not be allowed to use the coding information of non-refreshed area. Deblocking filtering may be disabled for the four pixels in refreshed area next to the virtual boundary. Alternatively, deblocking filtering may still be applied within the four pixels on the one side next to the virtual boundary, but with the coding information on the other side replaced with coding information from the one side, or with pre-determined values. For example, the four pixels on the other side may be padded from the one side (i.e. replaced by at least one of the four pixels of the one side). As shown in example of FIG. 5, deblocking filtering may still be applied to the four pixels in the refreshed area next to the virtual boundary, but with the four pixels on the non-refreshed area padded using coding information from the refreshed area.

Referring now to FIG. 5, illustrated is an example in which deblocking filtering may not be applied for a set of pixels 505 of the refreshed area 510, or may still be performed with a (padded) set of pixels 535 of the non-refreshed area 530. The refreshed area 510 and the non-refreshed area 530 may be separated by a virtual boundary 520. It may be noted that while FIG. 5 illustrates an example in which the set of pixels 505 of the refreshed area 510 comprises four pixels, and the set of pixels 535 of the non-refreshed area 530 comprises four pixels, this is non-limiting; each set of pixels may comprise more or fewer pixels, and the number of pixels in each set need not be equal.

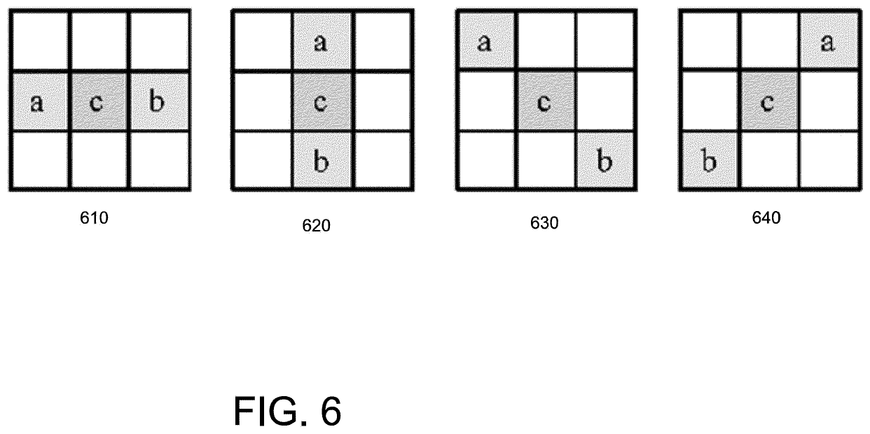

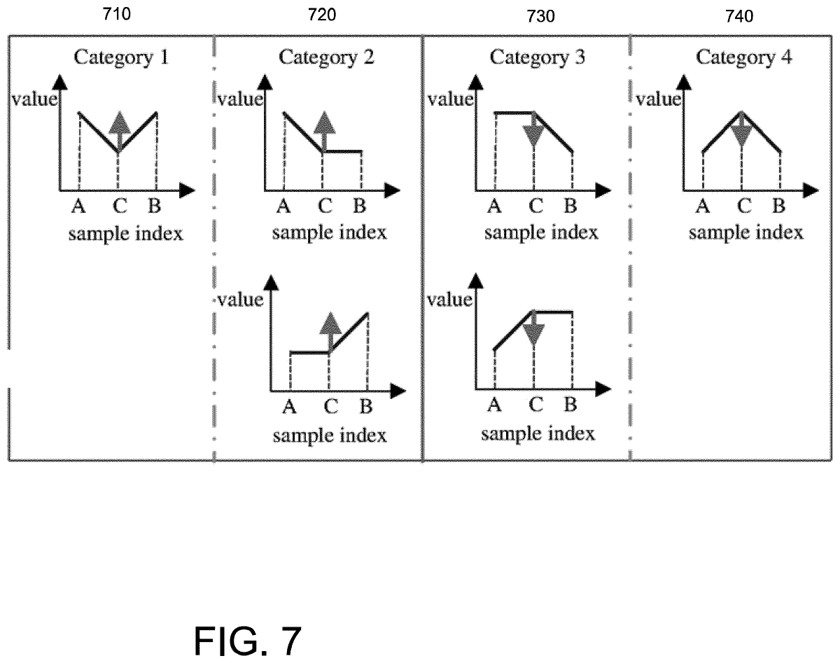

In an example embodiment, a sample adaptive offset (SAO) edge filter may be utilized. In VVC, SAO has two parts: band offset and edge offset. Each coding tree unit (CTU) may choose to use either band offset, or edge offset. The choice of band offset or edge offset per CTU may be signaled. For a CTU, if edge offset is used, a set of parameters (edge class, as shown in FIG. 6, and/or offsets for four edge categories, as shown in FIG. 7) may be signaled.

Referring now to FIG. 6, illustrated is an example of four edge classes. In example 610, pixels a and b are horizontally adjacent to pixel c. In example 620, pixels a and b are vertically adjacent to pixel c. In example 630, pixels a and b are adjacent to pixel c along a slope from the upper left to the lower right. In example 640, pixels a and b are adjacent to pixel c along a slop from the lower left to the upper right.

Referring now to FIG. 7, illustrated is an example of four edge categories. In category 1, 710, the value of pixel c is lower than the values of pixels a and b. In category 2, 720, the value of pixels c and b may be similar, while the value of pixel a may be higher than that of pixels c and b. Alternatively, the values of pixels a and c may be similar, while the value of pixel b may be higher than that of pixels a and c. In category 3, 730, the value of pixels a and c may be similar, while the value of pixel b may be lower than that of pixels a and c. Alternatively, the values of pixels c and b may be similar, while the value of pixel a may be lower than that of pixels c and b. In category 4, 740, the value of pixel c may be higher than that of pixels a and b.

As seen from FIGS. 6 and 7, categorizing the edge of a pixel may require use of the neighboring pixels.

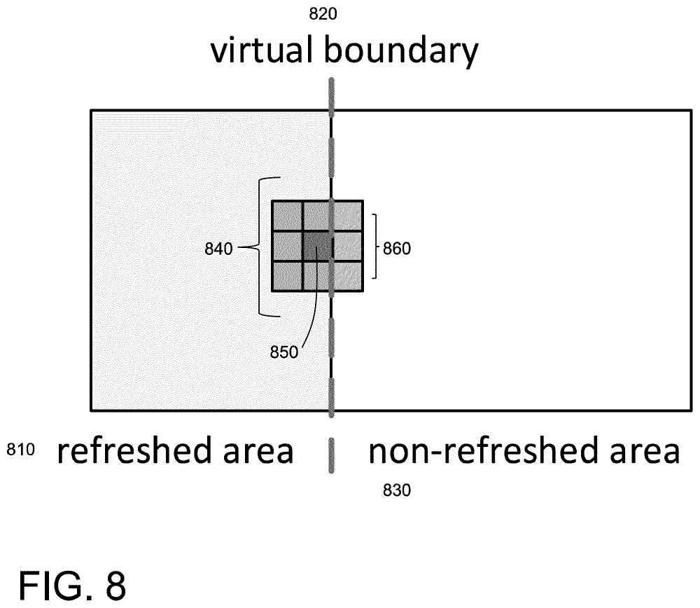

In an example embodiment, if one side of a virtual boundary is not allowed to use coding information on the other side of the virtual boundary, SAO edge offset may be skipped for pixels on the one side next to the virtual boundary. As shown in the example of FIG. 8, the refreshed area 810 of a GDR/recovering picture may not be allowed to use coding information of the non-refreshed area 830. SAO edge offset may be disabled for the pixel 850 in the refreshed area 830, which may be just next to the virtual boundary 820.

Alternatively, SAO edge offset may still be applied to the pixels on the said one side (850), but with the coding information on the other side replaced from the one side or set to pre-determined values. For example, pixels on the other side (860) may be padded from the said one side. As shown in example of FIG. 8, SAO edge offset may still be applied to the pixel 850 in refreshed area 810 next to the virtual boundary 820, but with the three pixels 860 on the non-refreshed area 830 padded from the refreshed area 810 (or set to a pre-determined value, e.g. 2^{BD-1}, where BD is bit depth).

Referring now to FIG. 8, illustrated is a refreshed area 810 separated by a virtual boundary 820 from a non-refreshed area 830. Five pixels 840 in the refreshed area 810 may surround a pixel 850 in the refreshed area 810. SAO edge offset may not be applied for the pixel 850, or may be performed with the three pixels 860 in the non-refreshed area 830 being padded. It should be noted that the number of pixels in each of 840, 850, and 860 are non-limiting; each set may comprise a different number of pixels than illustrated in FIG. 8.

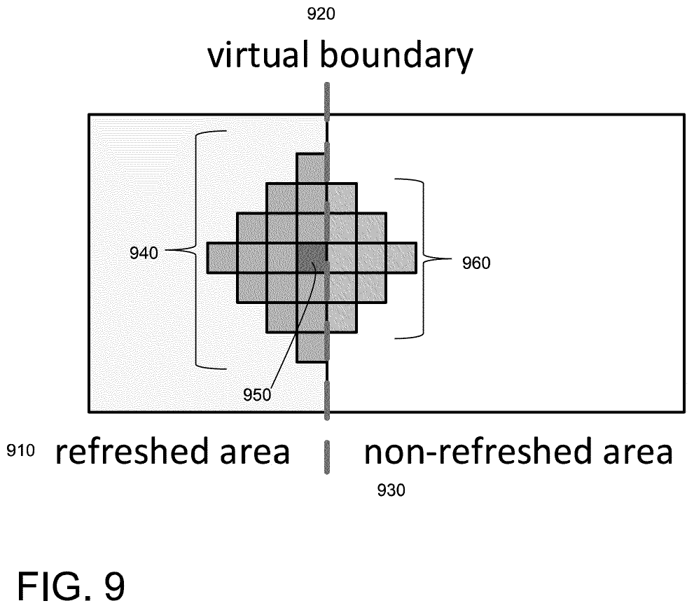

In an example embodiment, an ALF filter may be applied. In VVC, an ALF filter has a 7×7 diamond shaped filter. FIG. 9 shows an example of an ALF filter on a pixel 950 next to a virtual boundary 920. If one side of a virtual boundary is not allowed to use coding information on the other side of the virtual boundary, ALF filtering may be disabled within three pixels on the one side next to the virtual boundary. As shown in the example of FIG. 9, the refreshed area 910 of a GDR/recovering picture may not be allowed to use coding information of the non-refreshed area 930. ALF may not be performed for the pixel 950 in the refreshed area 910, which is just next to the virtual boundary 920. Alternatively, ALF may still be applied within the pixels 940 on the one side next 910 to the virtual boundary 920, but with the coding information on the said other side 930 replaced from the one side 910 or set to pre-determined values. For example, the pixels 960 on the other side 930 may be padded from the one side 910. As shown in the example of FIG. 9, ALF may still be performed for the pixel 950 in the refreshed area 910 next to the virtual boundary 920, but with the pixels 960 on the non-refreshed area 930 padded from the refreshed area 910 (or set to a pre-determined value, e.g. 2^{BD-1}, where BD is bit depth).

Referring now to FIG. 9, illustrated is a refreshed area 910 separated from a non-refreshed area 930 with a virtual boundary 920. Fifteen pixels 940 may surround one pixel 950 in the refreshed area 910 next to the virtual boundary 920. ALF may not be applied for the one pixel 950, or may still be performed with the nine pixels 960 of the non-refreshed area 930 being padded (e.g. based on the pixels 940). It should be noted that the number of pixels in each of 940, 950, and 960 are non-limiting; each set may comprise a different number of pixels than illustrated in FIG. 9.

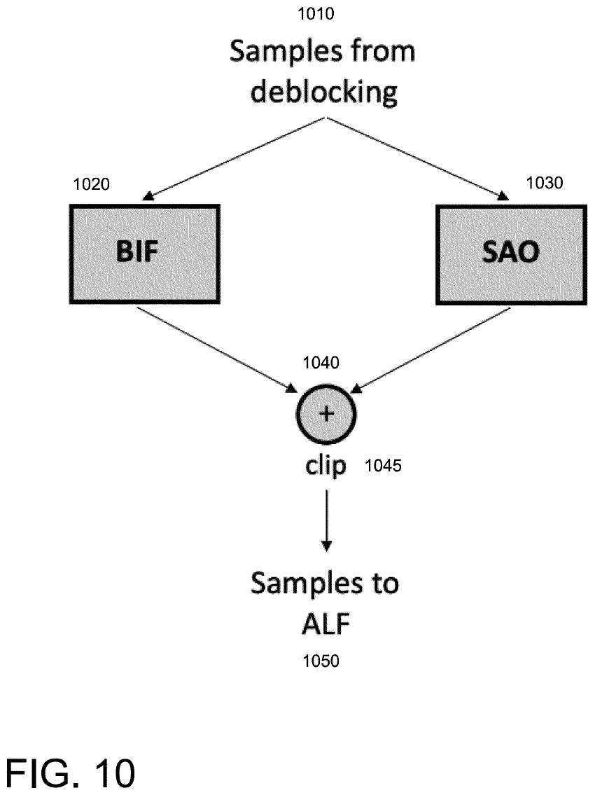

In an example embodiment, bilateral filter (BIF) for luma may be applied. ECM enhances the features of in-loop filters of VVC. Among them is the bilateral filter. The bilateral filter may be carried out in the sample adaptive offset (SAO) loop-filter stage, as shown in FIG. 10. Both the bilateral filter (BIF) and SAO may use samples from deblocking as input. Each filter may create an offset per sample, and these may be added to the input sample, and then clipped, before proceeding to ALF.

Referring now to FIG. 10, illustrated is an example of samples from deblocking 1010 being used by BIF 1020 and SAO 1030, and offsets from BIF 1020 and SAO 1030 being added 1040, to the deblocking output 1050 (which may be clipped 1045).

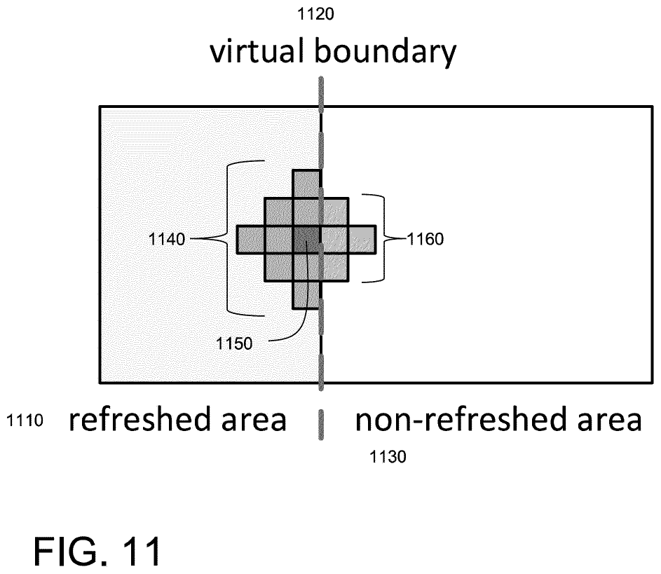

The bilateral filter may have a 5×5 diamond shaped filter, as shown in FIG. 11, where a bilateral filter may or may not be applied on a pixel 1150 next to a virtual boundary 1120. Referring now to FIG. 11, illustrated is an example of a refreshed area 1110 separated from a non-refreshed area 1130 by a virtual boundary 1120. Eight pixels 1140 surround a pixel 1150 in the refreshed area 1110 next to the virtual boundary. BIF may not be applied for the pixel 1150, or may still be performed with the four pixels 1160 in the non-refreshed area 1130 being padded, or set to pre-determined values. It should be noted that the number of pixels in each of 1140, 1150, and 1160 are non-limiting; each set may comprise a different number of pixels than illustrated in FIG. 11.

In an example embodiment, if one side 1110 of a virtual boundary 1120 is not allowed to use coding information on the other side 1130 of the virtual boundary 1120, bilateral filtering may be disabled within two pixels on the one side 1110 next to the virtual boundary 1120. As shown in example of FIG. 11, the refreshed area 1110 of a GDR/recovering picture may not be allowed to use coding information of the non-refreshed area 1130. Bilateral filtering may not be performed for the pixel 1150 in the refreshed area 1110 just next to the virtual boundary 1120. Alternatively, bilateral filtering may still be performed within the said two pixels on the one side 1110 next to the virtual boundary 1120, but with the coding information on the other side 1130 replaced from the one side 1110 or set to pre-determined values. For example, the pixels 1160 on the other side 1130 may be padded from the one side 1110. As shown in example of FIG. 11, bilateral filtering may still be applied to the pixel 1150 in the refreshed area 1110 next to the virtual boundary 1120, but with the pixels 1160 on the non-refreshed area 1130 padded from the refreshed area 1110 (or set to a pre-determined value, e.g. 2^{BD-1}, where BD is bit depth).

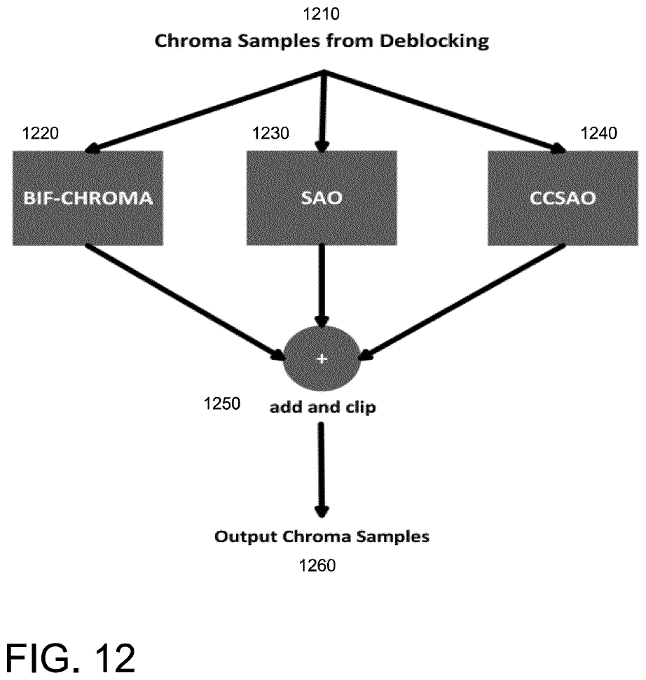

In an example embodiment, a bilateral filter for chroma (BIF-chroma) may be applied. Similar to BIF-luma, BIF-chroma may be performed in parallel with the SAO and CCSAO process, as shown in FIG. 12. BIF-chroma (1220), SAO (1230), and CCSAO (1240) may use the same chroma samples produced by the deblocking filter (1210) as input, and generate three offsets (per chroma sample) in parallel. Then, these three offsets may be added to the input chroma sample (1250) to obtain a sum, which may then be clipped to form the final output chroma sample value (1260). The BIF-chroma may provide an on/off control mechanism on the CTU level and the slice level.

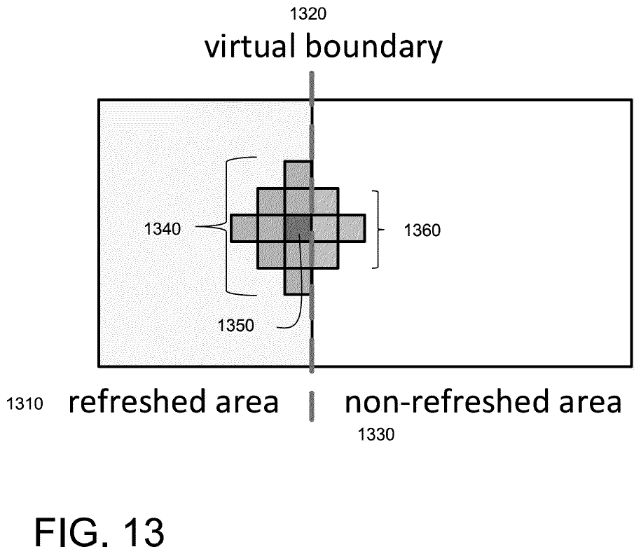

The filtering process of BIF-chroma may be similar to that of BIF-luma. For a chroma sample, a 5×5 diamond shaped filter may be used for generating the filtering offset, as shown in FIG. 13, where BIF-chroma may or may not be applied on a pixel 1350 next to a virtual boundary 1320. Referring now to FIG. 13, illustrated is an example of a refreshed area 1310 separated from a non-refreshed area 1330 by a virtual boundary 1320. Eight pixels 1340 surround a pixel 1350 in the refreshed area 1310 next to the virtual boundary 1320. The BIF-chroma may not be applied for the pixel 1350, or may still be performed with the four pixels 1360 in the non-refreshed area 1130 being padded, or set to pre-determined values. It should be noted that the number of pixels in each of 1340, 1350, and 1360 are non-limiting; each set may comprise a different number of pixels than illustrated in FIG. 13.

In an example embodiment, if one side 1310 of a virtual boundary 1320 may not be allowed to use coding information on the other side 1330 of the virtual boundary 1320, BIF-chroma may be disabled within two pixels on the one side 1310 next to the virtual boundary 1320. As shown in example of FIG. 13, the refreshed area 1310 of a GDR/recovering picture may not be allowed to use coding information of the non-refreshed area 1330. BIF-chroma may be skipped for the pixel 1350 in the refreshed area 1310 just next to the virtual boundary 1320. Alternatively, BIF-chroma may still be applied within the two pixels on the one side 1310 next to the virtual boundary 1320, but with the coding information on the other side 1330 replaced from the one side 1310 or set to pre-determined values. For example, the pixels 1360 on the other side 1330 may be padded from the one side 1310. As shown in the example of FIG. 13, BIF-chroma may still be applied to the pixel 1350 in the refreshed area 1310 next to the virtual boundary 1320, but with the pixels 1360 on the non-refreshed area 1330 padded from the refreshed area 1310 (or set to a pre-determined value, e.g. 2^{BD-1}, where BD is bit depth).

In an example embodiment, CCSAO may be applied. Cross-component Sample Adaptive Offset (CCSAO) may be used to refine reconstructed chroma samples. Similarly to SAO, the CCSAO classifies the reconstructed samples into different categories, derives one offset for each category, and adds the offset to the reconstructed samples in that category. However, different from SAO, which only uses one single luma/chroma component of current sample as input, the CCSAO utilizes all three components to classify the current sample into different categories. To facilitate the parallel processing, the output samples from the de-blocking filter may be used as the input of the CCSAO, as shown in FIG. 12.

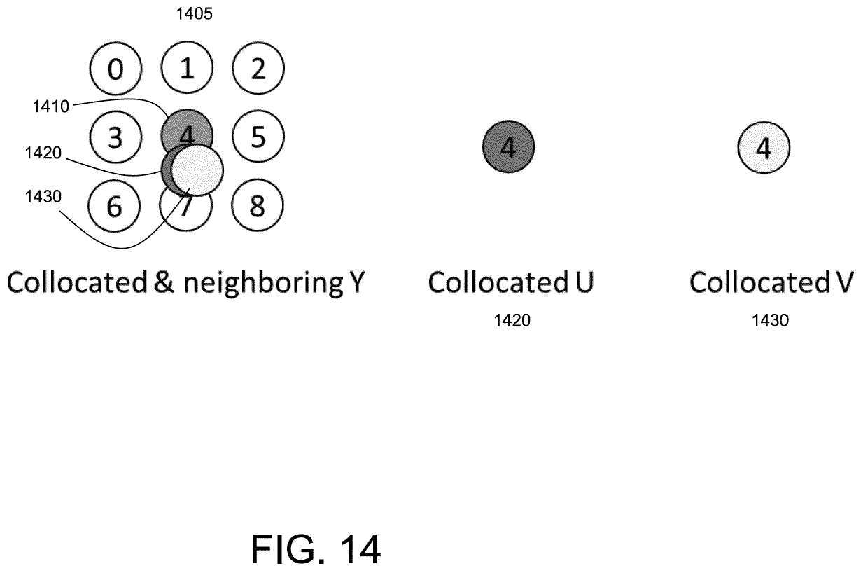

In CCSAO, either band offset (BO) classifier or edge offset (EO) classifier may be used to enhance the quality of the reconstructed samples. CCSAO may be applied to both luma and chroma components. For a given luma/chroma sample, three candidate samples may be selected to classify the given sample into different categories: one collocated Y sample (1410), one collocated U sample (1420), and one collocated V sample (1430). It may be noted that collocated Y sample 1410 may be any one of the 9 Y components illustrated at 1405; the example of FIG. 14 is not limiting. The sample values of these three selected samples may then be classified into three different bands, and a joint index may represent the category of the given sample. One offset may be signaled and added to the reconstructed samples that fall into that category.

For a collocated chroma sample, the collocated luma sample may be chosen from 9 candidate positions (1405), as depicted in FIG. 14. The nine candidate positions are illustrated at 1405. The collocated and neighboring sample Y (1410) may be located at position 4. The collocated sample U (1420) may be at least partially collocated at position 4 (i.e. the location of the collocated Y sample). The collocated sample V (1430) may be at least partially collocated at position 4 (i.e. the location of the collocated Y sample).

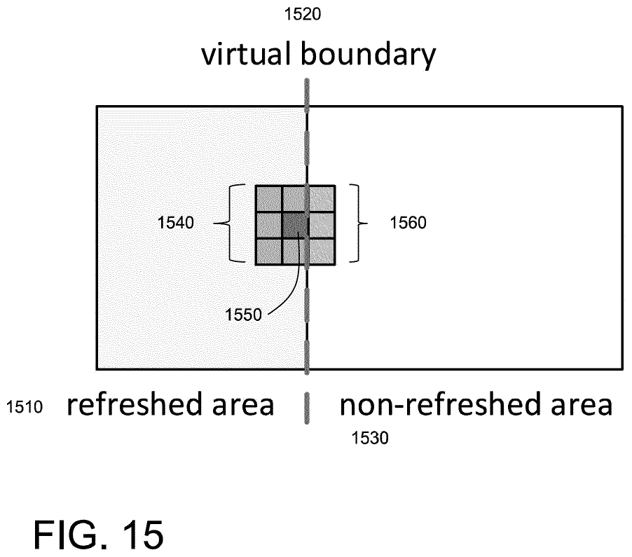

In an example embodiment, if one side 1510 of a virtual boundary 1520 is not allowed to use coding information on the other side 1530 of the virtual boundary 1520, CCSAO may be disabled within pixels 1560 on the one side 1510 next to the virtual boundary 1520. As shown in the example of FIG. 15, the refreshed area 1510 of a GDR/recovering picture may not be allowed to use coding information of the non-refreshed area 1530. CCSAO may be skipped for the pixel 1550 in the refreshed area 1510 just next to the virtual boundary 1520. Alternatively, CCSAO may still be applied within the pixels 1550 on the one side 1510 next to the virtual boundary 1520, but with the coding information on the other side 1530 replaced from the one side 1510 or set to pre-determined values. For example, the pixels 1560 on the other side 1530 may be padded from the one side 1510. As shown in the example of FIG. 15, CCSAO may still be applied to the pixel 1550 in refreshed area 1510 next to the virtual boundary 1520, but with the pixels 1560 on the non-refreshed area 1530 padded from the refreshed area 1510 (or set to a pre-determined value, e.g. 2^{BD-1}, where BD is bit depth).

Referring now to FIG. 15, illustrated is an example in which the refreshed area 1510 is separated from the non-refreshed area 1530 by the virtual boundary 1520. Five pixels 1540 surround one pixel 1550 in the refreshed area 1510 next to the virtual boundary 1520. CCSAO may not be applied for the pixel 1550 in the refreshed area 1510, or may still be performed with the three pixels 1560 in the non-refreshed area 153 being padded, or set to pre-determined values. It should be noted that the number of pixels in each of 1540, 1550, and 1560 are non-limiting; each set may comprise a different number of pixels than illustrated in FIG. 15.

SAO, Bilateral filter (BIF), and CCSAO offset may be computed in parallel, added to the reconstructed chroma samples, and jointly clipped, as shown in FIG. 12.

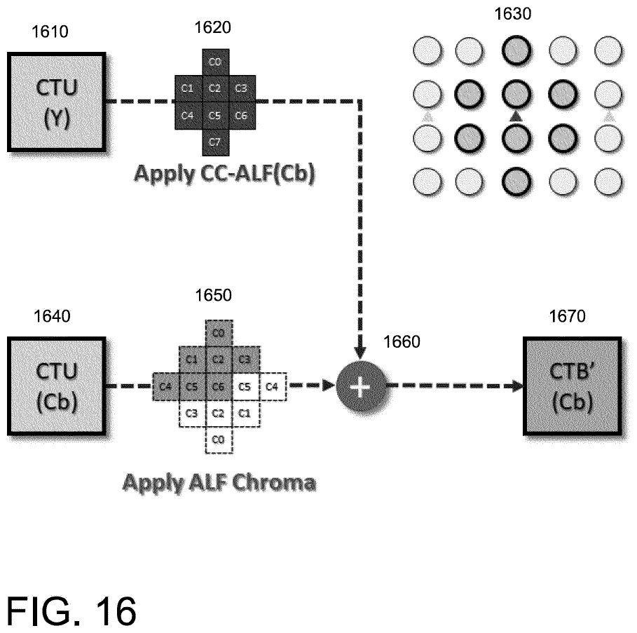

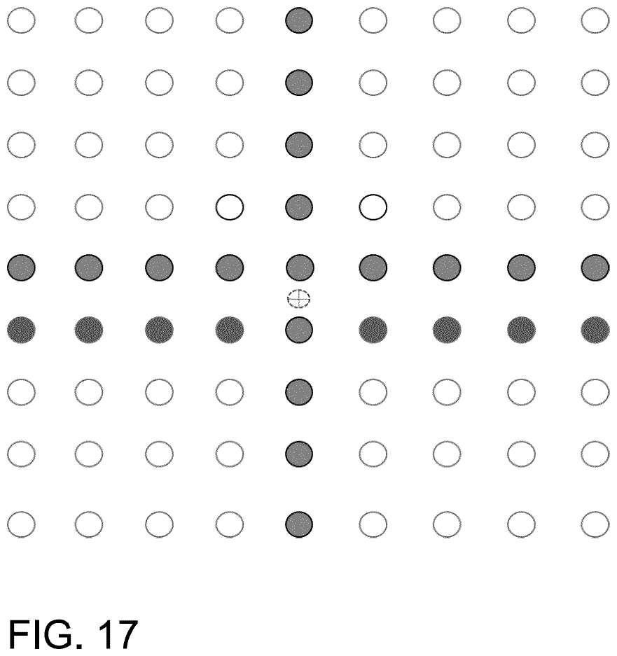

In an example embodiment, Longer CCALF may be applied. The CCALF process uses a linear filter to filter luma sample values and generate a residual correction for the chroma samples, as shown in FIG. 16. Initially, an 8-tap filer was designed for the CCALF process. Lately, a 25-tap large filter may be used in the CCALF process; this is illustrated in FIG. 17. For a given slice, the encoder can collect the statistics of the slice, analyze them, and can signal up to 16 filters through APS.

Referring now to FIG. 16, illustrated is a basic example of CCALF. At CTU (Y) 1610, CCALF (Cb) may be applied 1620 to a collection of pixels, as illustrated at 1630. This may be considered linear filtering of luma sample values. At CTU (Cb) 1640, ALF Chroma may be applied 1650 to a portion of the pixels. This may be considered filtering of chroma samples. The output of 1620 and 1650 may be added 1660, and output as CTB′ (Cb) 1670.

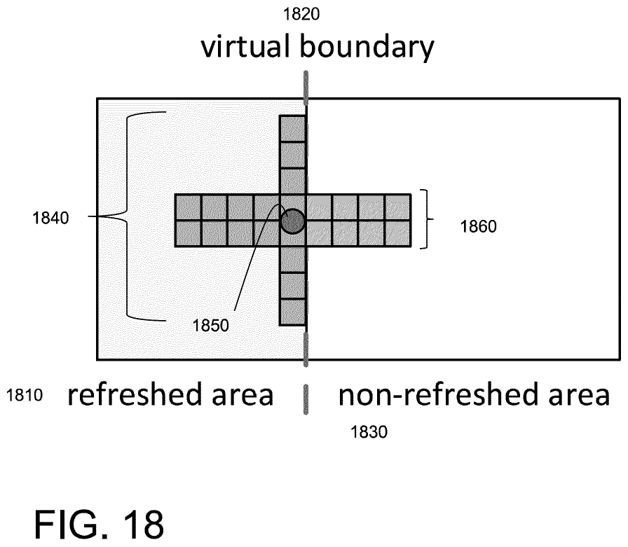

In an example embodiment, if one side 1810 of a virtual boundary 1820 is not allowed to use coding information on the other side 1830 of the virtual boundary 1820, longer CCALF may be disabled within four pixels on the one side 1810 next to the virtual boundary 1820. As shown in the example of FIG. 18, the refreshed area 1810 of a GDR/recovering picture may not be allowed to use coding information of the non-refreshed area 1830. Longer CCALF may be skipped for the collocated chroma pixel 1850 in the refreshed area 1810 just next to the virtual boundary 1820. Alternatively, longer CCALF may still be applied within the four pixels on the one side 1810 next to the virtual boundary 1820, but with the coding information on the other side 1830 replaced from the one side 1810 or set to pre-determined values. For example, the pixels 1860 on the other side 1830 may be padded from the one side 1810. As shown in the example of FIG. 18, Longer CCALF may still be applied to the collocated chroma pixel 1850 in the refreshed area 1810 next to the virtual boundary 1820, but with the pixels 1860 on the non-refreshed area 1830 padded from the refreshed area 1810 (or set to a pre-determined value, e.g. 2^{BD-1}, where BD is bit depth).

Referring now to FIG. 18, illustrated is an example in which a refreshed area 1810 is separated from a non-refreshed area 1830 with a virtual boundary 1820. Sixteen pixels 1840 surround a collocated chroma pixel 1850 in the refreshed area 1810 next to the virtual boundary 1820. Longer CCALF may not be applied for the collocated chroma pixel 1850, or may still be performed with the eight pixels 1860 in the non-refreshed area 1830 being padded, or set to pre-determined values.

In an example embodiment, an alternative band classifier for ALF filter (ABN-ALF) may be applied. ECM may use a 13×13 diamond filter for classifying each 2×2 luma block for ALF.

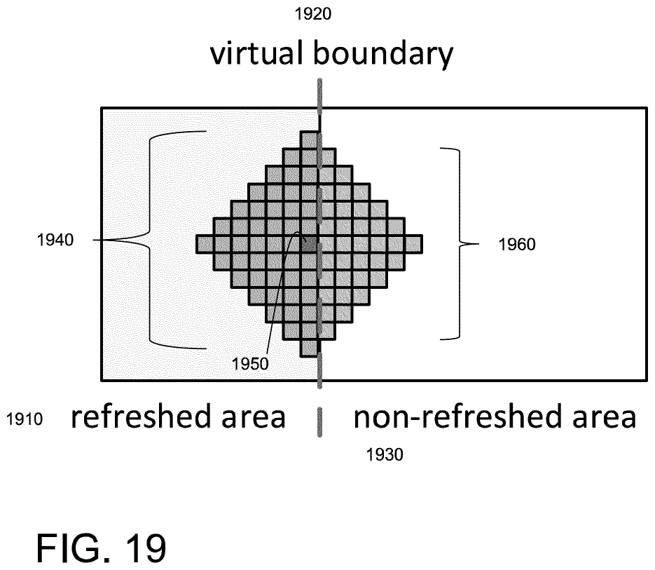

In an example embodiment, if one side 1910 of a virtual boundary 1920 is not allowed to use coding information on the other side 1930 of the virtual boundary 1920, ABN-ALF may be disabled within six pixels on the one side 1910 next to the virtual boundary 1920. As shown in the example of FIG. 19, the refreshed area 1910 of a GDR/recovering picture may not be allowed to use coding information of the non-refreshed area 1930. ABN-ALF may be skipped for the pixel 1950 in the refreshed area 1910 just next to the virtual boundary 1920. Alternatively, ABN-ALF may still be applied within the six pixels on the one side 1910 next to the virtual boundary 1920, but with the coding information on the other side 1930 replaced from the one side 1910 or set to pre-determined values. For example, the pixels 1960 on the other side 1930 may be padded from the one side 1910. As shown in the example of FIG. 19, ABN-ALF may still be applied to the pixel 1950 in the refreshed area 1910 next to the virtual boundary 1920, but with the pixels 1960 on the non-refreshed area 1930 padded from the refreshed area 1910 (or set to a pre-determined value, e.g. 2^{BD-1}, where BD is bit depth).

Referring now to FIG. 19, illustrated is an example in which the refreshed area 1910 is separated from the non-refreshed area 1930 with the virtual boundary 1920. Forty-eight pixels 1940 surround one pixel 1950 in the refreshed area 1910 next to the virtual boundary 1920. ANN-ALF may not be applied for the pixel 1950, or may still be performed with the thirty-six pixels 1960 in the non-refreshed area 1930. It should be noted that the number of pixels in each of 1940, 1950, and 1960 are non-limiting; each set may comprise a different number of pixels than illustrated in FIG. 19.

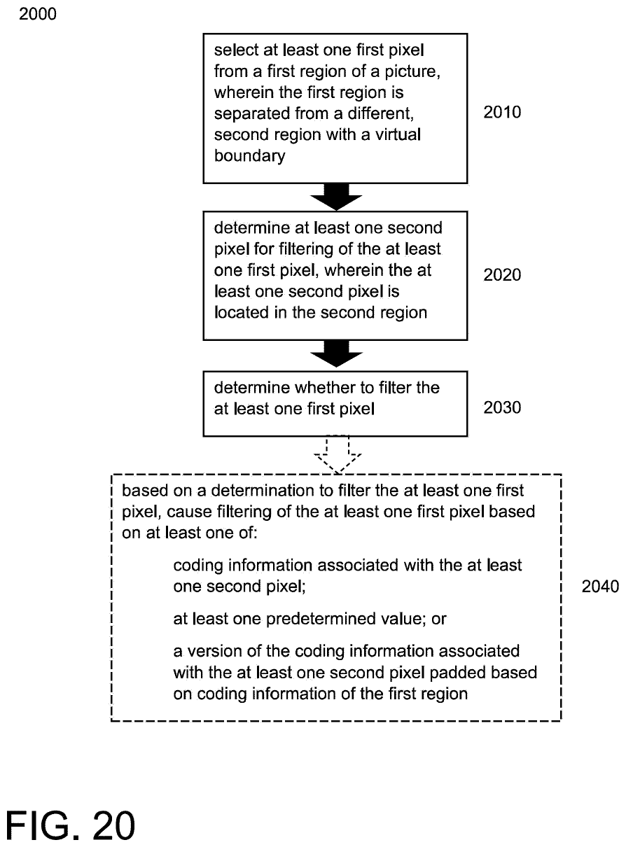

FIG. 20 illustrates the potential steps of an example method 2000. The example method 2000 may include: selecting at least one first pixel from a first region of a picture, wherein the first region is separated from a different, second region with a virtual boundary, 2010; determining at least one second pixel for filtering of the at least one first pixel, wherein the at least one second pixel is located in the second region, 2020; determining whether to filter the at least one first pixel, 2030; and, based on a determination to filter the at least one first pixel, filtering the at least one first pixel based on at least one of: coding information associated with the at least one second pixel; at least one predetermined value; or a version of the coding information associated with the at least one second pixel padded based on coding information of the first region, 2040. It may be noted that filtering the at least one first pixel is optional; not filtering the at least one first pixel is also an option. Determining whether to filter the at least one first pixel may be based on a default setting/configuration, signaling in a sequence header, signaling in a picture header, and/or signaling in a slice header.

In accordance with one example embodiment, an apparatus may comprise: at least one processor; and at least one memory including computer program code; the at least one memory and the computer program code configured to, with the at least one processor, cause the apparatus at least to: select at least one first pixel from a first region of a picture, wherein the first region may be separated from a different, second region with a virtual boundary; determine at least one second pixel for filtering of the at least one first pixel, wherein the at least one second pixel may be located in the second region; determine whether to filter the at least one first pixel; and based on a determination to filter the at least one first pixel, cause filtering of the at least one first pixel based on at least one of: coding information associated with the at least one second pixel; at least one predetermined value; or a version of the coding information associated with the at least one second pixel padded based on coding information of the first region.

The at least one first pixel may be adjacent to the virtual boundary.

The filtering may comprise performing at least one in-loop filter, wherein the at least one in-loop filter comprises at least one of: a deblocking filter, a sample adaptive offset filter, or an adaptive loop filter.

The picture may comprise one of: a three-hundred and sixty degree picture, a gradual decoding refresh picture, a recovering picture, or a picture comprising of sub-pictures or tiles.

The first region may comprise a refreshed area of the picture, wherein the second region may comprise a non-refreshed area of the picture.

The coding information associated with the at least one second pixel may comprise at least one of: pixel information, a coding mode, a motion vector, or a quarter pixel associated with the at least one second pixel.

The example apparatus may be further configured to: determine whether to filter the at least one first pixel based on at least one of: a configuration, signaling in a sequence header, signaling in a picture header, or signaling in a slice header.

The at least one predetermined value may comprise two raised to a power comprising a bit depth of the picture minus one.

The filtering of the at least one first pixel may comprise performing deblocking filtering, wherein a block boundary for the deblocking filtering may be aligned with the virtual boundary.

The filtering of the at least one first pixel may comprise performing sample adaptive offset edge filtering.

The filtering of the at least one first pixel may comprise performing adaptive loop filtering, wherein the adaptive loop filtering may comprise use of a seven-by-seven diamond shaped filter.

The filtering of the at least one first pixel may comprise performing bilateral filtering for luma, wherein the bilateral filtering for luma may comprise use of a five-by-five diamond shaped filter.

The filtering of the at least one first pixel may comprise performing bilateral filtering for chroma, wherein the bilateral filtering for chroma may comprise use of a five-by-five diamond shaped filter.

The filtering of the at least one first pixel may comprise performing cross-component sample adaptive offset filtering based on at least one of: a band offset classifier, or an edge offset classifier.

The filtering of the at least one first pixel may comprise performing longer cross-component adaptive loop filtering, wherein the longer cross-component adaptive loop filtering may comprise use of a twenty-five tap large filter.

The filtering of the at least one first pixel may comprise performing alternative band classifier for adaptive loop filtering, wherein the alternative band classifier for adaptive loop filtering may comprise use of a respective thirteen-by-thirteen diamond filter for classifying one or more two-by-two luma blocks.

The example apparatus may be further configured to: based on a determination to not filter the at least one first pixel, not cause filtering of the at least one first pixel.

In accordance with one aspect, an example method may be provided comprising: selecting at least one first pixel from a first region of a picture, wherein the first region may be separated from a different, second region with a virtual boundary; determining at least one second pixel for filtering of the at least one first pixel, wherein the at least one second pixel may be located in the second region; determining whether to filter the at least one first pixel; and based on a determination to filter the at least one first pixel, filtering the at least one first pixel based on at least one of: coding information associated with the at least one second pixel; at least one predetermined value; or a version of the coding information associated with the at least one second pixel padded based on coding information of the first region.

In accordance with one example embodiment, an apparatus may comprise: circuitry configured to perform: select at least one first pixel from a first region of a picture, wherein the first region may be separated from a different, second region with a virtual boundary; determine at least one second pixel for filtering of the at least one first pixel, wherein the at least one second pixel may be located in the second region; determine whether to filter the at least one first pixel; and based on a determination to filter the at least one first pixel, cause filtering of the at least one first pixel based on at least one of: coding information associated with the at least one second pixel; at least one predetermined value; or a version of the coding information associated with the at least one second pixel padded based on coding information of the first region.

In accordance with one example embodiment, an apparatus may comprise: processing circuitry; memory circuitry including computer program code, the memory circuitry and the computer program code configured to, with the processing circuitry, enable the apparatus to: select at least one first pixel from a first region of a picture, wherein the first region may be separated from a different, second region with a virtual boundary; determine at least one second pixel for filtering of the at least one first pixel, wherein the at least one second pixel may be located in the second region; determine whether to filter the at least one first pixel; and based on a determination to filter the at least one first pixel, cause filtering of the at least one first pixel based on at least one of: coding information associated with the at least one second pixel; at least one predetermined value; or a version of the coding information associated with the at least one second pixel padded based on coding information of the first region.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog digital with and/or hardware circuit(s) software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: selecting at least one first pixel from a first region of a picture, wherein the first region may be separated from a different, second region with a virtual boundary; determining at least one second pixel for filtering of the at least one first pixel, wherein the at least one second pixel may be located in the second region; determining whether to filter the at least one first pixel; and based on a determination to filter the at least one first pixel, filtering the at least one first pixel based on at least one of: coding information associated with the at least one second pixel; at least one predetermined value; or a version of the coding information associated with the at least one second pixel padded based on coding information of the first region.

In accordance with one example embodiment, a non-transitory comprising program computer-readable medium instructions stored thereon which, when executed with at least one processor, cause the at least one processor to: select at least one first pixel from a first region of a picture, wherein the first region may be separated from a different, second region with a virtual boundary; determine at least one second pixel for filtering of the at least one first pixel, wherein the at least one second pixel may be located in the second region; determine whether to filter the at least one first pixel; and based on a determination to filter the at least one first pixel, cause filtering of the at least one first pixel based on at least one of: coding information associated with the at least one second pixel; at least one predetermined value; or a version of the coding information associated with the at least one second pixel padded based on coding information of the first region.

In accordance with another example embodiment, a non-transitory program storage device readable by a machine may be provided, tangibly embodying a program of instructions executable by the machine for performing operations, the operations comprising: select at least one first pixel from a first region of a picture, wherein the first region may be separated from a different, second region with a virtual boundary; determine at least one second pixel for filtering of the at least one first pixel, wherein the at least one second pixel may be located in the second region; determine whether to filter the at least one first pixel; and based on a determination to filter the at least one first pixel, cause filtering of the at least one first pixel based on at least one of: coding information associated with the at least one second pixel; at least one predetermined value; or a version of the coding information associated with the at least one second pixel padded based on coding information of the first region.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1-20. (canceled)

21. An apparatus comprising:
at least one processor; and
at least one memory including computer program code;
the at least one memory and the computer program code configured to, with the at least one processor, cause the apparatus at least to:
select at least one first pixel from a first region of a picture, wherein the first region is separated from a different, second region with a virtual boundary;
determine at least one second pixel for filtering of the at least one first pixel, wherein the at least one second pixel is located in the second region;
determine whether to filter the at least one first pixel; and
based on a determination to filter the at least one first pixel, cause filtering of the at least one first pixel based on at least one of:
coding information associated with the at least one second pixel;
at least one predetermined value; or
a version of the coding information associated with the at least one second pixel padded based on coding information of the first region.

22. The apparatus of claim 21, wherein the at least one first pixel is adjacent to the virtual boundary.

23. The apparatus of claim 21, wherein to perform filtering the apparatus further caused to perform at least one in-loop filter, wherein the at least one in-loop filter comprises at least one of:
a deblocking filter;
a sample adaptive offset filter; or
an adaptive loop filter.

24. The apparatus of claim 21, wherein the picture comprises one of:
a three-hundred and sixty degree picture;
a gradual decoding refresh picture;
a recovering picture; or
a picture comprising of sub-pictures or tiles.

25. The apparatus of claim 21, wherein the first region comprises a refreshed area of the picture, and wherein the second region comprises a non-refreshed area of the picture.

26. The apparatus of claim 21, wherein the coding information associated with the at least one second pixel comprises at least one of:
pixel information;
a coding mode;
a motion vector; or
a quarter pixel

27. The apparatus of claim 21, wherein the at least one memory and the computer program code are further configured to, with the at least one processor, cause the apparatus to determine whether to filter the at least one first pixel based on at least one of:
a configuration;
signaling in a sequence header;
signaling in a picture header; or
signaling in a slice header.

28. The apparatus of claim 21, wherein the at least one predetermined value comprises two raised to a power comprising a bit depth of the picture minus one.

29. The apparatus of claim 21, wherein the to perform filtering of the at least one first pixel the apparatus further caused to perform deblocking filtering, wherein a block boundary for the deblocking filtering is aligned with the virtual boundary.

30. The apparatus of claim 21, wherein to perform filtering of the at least one first pixel the apparatus further caused to perform sample adaptive offset edge filtering.

31. The apparatus of claim 21, wherein to perform filtering of the at least one first pixel the apparatus further caused to perform an adaptive loop filtering, wherein the adaptive loop filtering comprises use of a seven-by-seven diamond shaped filter.

32. The apparatus of claim 21, wherein to perform filtering of the at least one first pixel the apparatus further caused to perform bilateral filtering for luma samples, wherein the bilateral filtering for the luma samples comprises use of a five-by-five diamond shaped filter.

33. The apparatus of claim 21, wherein to perform filtering of the at least one first pixel the apparatus further caused to perform a bilateral filtering for chroma samples, wherein the bilateral filtering for the chroma samples comprises use of a five-by-five diamond shaped filter.

34. The apparatus of claim 21, wherein to perform filtering of the at least one first pixel the apparatus further caused to perform perform cross-component sample adaptive offset filtering based on at least one of: a band offset classifier, or an edge offset classifier.

35. The apparatus of claim 21, wherein to perform filtering of the at least one first pixel the apparatus further caused to perform a longer cross-component adaptive loop filtering, wherein the longer cross-component adaptive loop filtering comprises use of a twenty-five tap large filter.

36. The apparatus of claim 21, wherein to perform filtering of the at least one first pixel the apparatus further caused to perform alternative band classifier for the adaptive loop filtering, wherein the alternative band classifier for the adaptive loop filtering comprises use of a respective thirteen-by-thirteen diamond filter for classifying one or more two-by-two luma blocks.

37. The apparatus of claim 21, wherein the at least one memory and the computer program code are configured to, with the at least one processor, cause the apparatus to, based on a determination to not filter the at least one first pixel, not cause filtering of the at least one first pixel.

38. A method comprising:
selecting at least one first pixel from a first region of a picture, wherein the first region is separated from a different, second region with a virtual boundary:
determining at least one second pixel for filtering of the at least one first pixel, wherein the at least one second pixel is located in the second region:
determining whether to filter the at least one first pixel; and
based on a determination to filter the at least one first pixel, filtering the at least one first pixel based on at least one of:
coding information associated with the at least one second pixel:
at least one predetermined value: or
a version of the coding information associated with the at least one second pixel padded based on coding information of the first region.

39. A non-transitory computer-readable medium comprising program instructions stored thereon which, when executed with at least one processor, cause the at least one processor to:
select at least one first pixel from a first region of a picture, wherein the first region is separated from a different, second region with a virtual boundary:
determine at least one second pixel for filtering of the at least one first pixel, wherein the at least one second pixel is located in the second region;
determine whether to filter the at least one first pixel; and
based on a determination to filter the at least one first pixel, cause filtering of the at least one first pixel based on at least one of:
coding information associated with the at least one second pixel;
at least one predetermined value; or
a version of the coding information associated with the at least one second pixel padded based on coding information of the first region.
